(19) United States
(12) Patent Application Publication
(10) Pub. No.: US 2014/0301396 A1
(43) Pub. Date: Oct. 9, 2014

(54) METHOD FOR CONSTRUCTING VIRTUAL PRIVATE NETWORK, METHOD FOR PACKET FORWARDING, AND GATEWAY APPARATUS USING THE METHODS

(71) Applicant: ELECTRONICS & TELECOMMUNICATIONS RESEARCH INSTITUTE, Daejeon (KR)

(72) Inventors: Seung Woo HONG, Daejeon (KR); Ho Yong RYU, Daejeon (KR)

(73) Assignee: ELECTRONICS & TELECOMMUNICATIONS RESEARCH INSTITUTE, Daejeon (KR)

(21) Appl. No.: 14/248,445

(22) Filed: Apr. 9, 2014

(30) Foreign Application Priority Data
Apr. 9, 2013 (KR) 10-2013-0038610

(51) Int. Cl. H04L 12/947; H04L 12/741

(52) U.S. Cl. CPC H04L 49/25; H04L 45/745
USPC 370/392

(57) ABSTRACT

Disclosed are a method for constructing a virtual private network, a method for packet forwarding, and a gateway apparatus using the methods. A method for constructing a virtual private network, according to an example embodiment of the present invention, may comprise receiving a first tunnel connection request from the lower gateway, and transmitting a permission message for the first tunnel connection request to the lower gateway; transmitting a second tunnel connection request to the upper gateway, and receiving a permission message for the second tunnel connection request from the upper gateway; and generating a second tunnel, and storing information about the second tunnel in a tunnel routing table.

### CLAIM FOR PRIORITY

This application claims priorities to Korean Patent Application No. 10-2013-0038610 filed on Apr. 9, 2014 in the Korean Intellectual Property Office (KIPO), the entire contents of which are hereby incorporated by references.

### BACKGROUND

1. Technical Field

Example embodiments of the present invention relate to a method for constructing a virtual private network, a method for packet forwarding, and a gateway apparatus using the methods, and more specifically to a method for constructing a hierarchical virtual private network, a method for packet forwarding for the constructed virtual private network, and a gateway apparatus using such the methods.

2. Related Art

Enterprise subscribers have leased dedicated lines based on point-to-point connections from a network operator, constructed their own wide area network (WAN) through them, and used it. Such the network is referred to as a private network. Generally, in a geographically distributed enterprise environment, a method of leasing a dedicated line (a lease line) for connecting a head office and a plurality of branch offices, and constructing a private network using the dedicated line has been used.

However, since such the lease line is relatively expensive, efforts to construct a private network using a public network has been tried as an inexpensive method for constructing a private network.

As described above, a case in which a function of a private network is provided using a public network may be referred to as a virtual private network (VPN). As internet grows, many network operators have substituted conventional networks such as a Frame Relay (FR), an Asynchronous Transfer Mode (ATM), etc. with an internet protocol (IP) network. Accordingly, many technologies for providing a virtual private network by utilizing the IP networks have been developed.

Since such the virtual private network only connects a private communication network in a corporation to a public internet, it is not required separately to purchase and manage expensive apparatuses and software. Therefore, as compared to the conventional methods of connecting private networks, an effect of saving cost may be achieved. Also, there may be an advantage in that homeworkers and workers having frequent business trips as well as workers currently resident in an office can access a corporate private network through an internet service provider (ISP) and an internet.

That is, since the virtual private network uses a public network, it becomes possible to share data between a head office and branch offices, between branch offices, and between workers outside of the office in a more flexible and inexpensive manner. As a method of constructing a virtual private network, there is a method of providing connections on internet which is a packet-based connectionless network by using specific protocols such as a Multi-Protocol Label Switching (MPLS), a Layer 2 VPN (L2VPN), a Layer 3 VPN (L3VPN), a Layer 2 Tunneling Protocol (L2TP), a Point-to-Point Tunneling Protocol (PPTP), etc. or a method of constructing a virtual private network by using security functions such as an IP Security (IPSec), a Secure Sockets Layer (SSL), etc. additionally.

However, in conventional MPLS L2VPN, L3VPN, L2TP, P2TP, in a case in which they are configured based on an End-to-End connection manner, they have disadvantages in connecting multiple points simultaneously. Also, in a case in which they are configured based on a center concentrated star-type connection manner, there may be a problem that excessive network load occurs in a center gateway, or an overall network may be stopped when a network failure occurs in the center domain network.

Therefore, demanded is an efficient method of connecting virtual private networks necessary for connecting a large scale of domain networks distributed in a wide area.

### SUMMARY

Accordingly, example embodiments of the present invention are provided to substantially obviate one or more problems due to limitations and disadvantages of the related art.

Example embodiments of the present invention provide a method of constructing a hierarchical virtual private network.

Example embodiments of the present invention also provide a method of packet forwarding using the virtual private network.

Example embodiments of the present invention also provide a gateway apparatus using the method of constructing a hierarchical virtual private network and the method of packet forwarding.

In some example embodiments, a method for constructing a virtual private network, performed in a gateway connected to an upper gateway and a lower gateway, may comprise receiving a connection request of a first tunnel from the lower gateway, and transmitting a permission message for the connection request of the first tunnel to the lower gateway; transmitting a connection request of a second tunnel to the upper gateway, and receiving a permission message for the connection request of the second tunnel from the upper gateway; and generating the second tunnel, and storing information about the second tunnel in a tunnel routing table.

Here, the method may further comprise receiving a tunnel route configuration request from the lower gateway; generating a tunnel routing entry for the tunnel route configuration request; and transmitting, to the upper gateway, a request identical to the tunnel route configuration request received from the lower gateway.

Here, the first tunnel may be generated by the lower gateway.

Here, the tunnel routing table may include at least one tunnel routing entry.

Here, the tunnel routing table may include information about a prefix, a destination address, and a source address for each tunnel routing entry.

Here, the method may further comprise receiving a first tunnel packet through the first tunnel and the second tunnel.

Also, the method may further comprise removing a first tunnel header included in the first tunnel packet; searching the tunnel routing table for a destination address of an original data in the first tunnel packet in which the first tunnel header is removed; and obtaining route information corresponding to the first tunnel packet through the tunnel routing table search.

Also, the method may further comprise generating a second tunnel header according to the obtained route information; generating a second tunnel packet by inserting the second tunnel header into an original packet data to be forwarded; and forwarding the generated second tunnel packet.

Also, the first tunnel header may include a source address and a destination address of the first tunnel, and the second tunnel header may include a source address and a destination address of the second tunnel.

In other example embodiments, a method for packet forwarding, performed in a tree gateway connected hierarchically to at least one other gateway, may comprise performing a tunnel connection with the at least one other gateway connected to the tree gateway hierarchically in an upper relation or a lower relation; generating a tunnel route according to a tunnel route configuration request received through the connected tunnel; and performing a tunnel header process on a packet inputted through the generated tunnel route.

Here, the method may further comprise transmitting the packet on which the tunnel header process is performed.

Here, the performing a tunnel header process on a packet inputted through the generated tunnel route may comprise removing a first tunnel header included in a first tunnel packet received; and generating a second tunnel packet by inserting a second tunnel header into the packet the first tunnel header of which is removed according to the tunnel route.

In other example embodiments, a tree gateway apparatus connected hierarchically to at least one other gateway may comprise a tunnel generating part generating a tunnel connected to at least one other gateway connected hierarchically to the tree gateway apparatus in an upper position or a lower position, and generating a tunnel route according to a tunnel route configuration request received from the connected tunnel; and a routing information storing part storing information about the generated tunnel and the tunnel route.

Here, the apparatus may further comprise a packet receiving part receiving a packet including at least one of a tunnel generation request, a route generation request, and a tunnel packet from the at least one other gateway connected hierarchically.

Also, the apparatus may further comprise a forwarding engine searching a tunnel routing table stored in the routing information storing part for a destination address of an original IP header included in a tunnel packet received from the packet receiving part, and obtaining route information corresponding to the packet.

Also, the forwarding engine may generate a new tunnel header according to the obtained route information, insert the tunnel header into a packet to be transmitted, and forward the generated packet to a next destination.

Also, the forwarding engine may remove a first tunnel header included in a first tunnel packet received, generate a second tunnel packet by inserting a second tunnel header into a packet the first tunnel header of which is removed according to the tunnel route information, and forward the generated second tunnel packet.

Also, the routing information storing part may include a tunnel routing table comprising at least one tunnel routing entry.

Also, the tunnel routing table may include information about a prefix, a destination address, and a source address for each tunnel routing entry.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram to illustrate a conventional VPN connection based on end-to-end connection manner;

FIG. 2 is a conceptual diagram to illustrate a general VPN connection according to a star-type connection method in a center concentration manner;

FIG. 3 is a conceptual diagram to illustrate a configuration of a virtual private network having a hierarchical structure according to an example embodiment of the present invention;

FIG. 4 is a view to illustrate an example of utilizing a VPN service using a method of constructing a virtual private network according to an example embodiment of the present invention;

FIG. 5 is a conceptual diagram to illustrate a method for tunnel connection and tunnel routing according to an example embodiment of the present invention;

FIG. 6 is a view to illustrate a procedure of tunnel connection and a method of configuring a tunnel routing table according to an example embodiment of the present invention;

FIGS. 7A and 7B are flow charts of a method of constructing a hierarchical virtual private network according to an example embodiment of the present invention;

FIG. 8 is a flow chart to illustrate an operation for tunnel routing of a VPN service packet according to an example embodiment of the present invention;

FIG. 9 is a flow chart to illustrate a method for packet forwarding according to an example embodiment of the present invention; and

FIG. 10 is a block diagram to illustrate a tree gateway according to an example embodiment of the present invention.

### DESCRIPTION OF EXAMPLE EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The term “terminal” used in this specification may be referred to as User Equipment (UE), a User Terminal (UT), a wireless terminal, an Access Terminal (AT), a Subscriber Unit (SU), a Subscriber Station (SS), a wireless device, a wireless communication device, a Wireless Transmit/Receive Unit (WTRU), a mobile node, a mobile, or other words. The terminal may be a cellular phone, a smart phone having a wireless communication function, a Personal Digital Assistant (PDA) having a wireless communication function, a wireless modem, a portable computer having a wireless communication function, a photographing device such as a digital camera having a wireless communication function, a gaming device having a wireless communication function, a music storing and playing appliance having a wireless communication function, an Internet home appliance capable of wireless Internet access and browsing, or also a portable unit or terminal having a combination of such functions. However, the terminal is not limited to the above-mentioned units.

Hereinafter, embodiments of the present invention will be described in detail with reference to the appended drawings. In the following description, for easy understanding, like numbers refer to like elements throughout the description of the figures, and the same elements will not be described further.

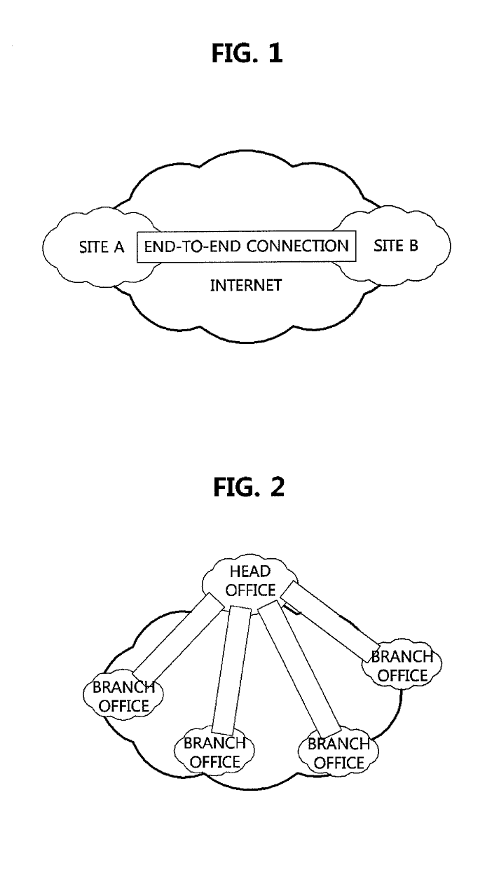

FIG. 1 is a conceptual diagram to illustrate a conventional VPN connection based on End-to-End connection manner.

FIG. 1 represents a general VPN connection concept using End-to-End manner. End-points (a site A and a site B) may be connected to each other through an internet in a point-to-point connection manner.

The End-to-End manner, which is depicted in FIG. 1, may be used generally in a VPN utilizing Multi-Protocol Label Switching (MPLS), a layer 2 VPN (L2VPN), a layer 3 VPN (L3VPN), a Layer 2 Tunneling Protocol (L2TP), a Point-to-Point Tunneling Protocol (PPTP), etc.

Here, a VPN provided in a communication network may be classified into a subscriber based VPN (Customer Premise Equipment based VPN: CPE-VPN) and a network operator based VPN (Provider-Provisioned VPN: PPVPN). Also, if a VPN is classified according to its operation layer, a VPN may be classified into a layer 2 VPN (L2VPN) and a layer 3 VPN (L3VPN).

In the case of VPN using a Layer 2 Tunneling Protocol (L2TP) or a Point-to-Point Tunneling Protocol (PPTP) which corresponds to L2VPN among the CPE-VPN technologies, an IP packet or an Internetwork Packet Exchange (IPX) packet of a subscriber network is capsulized using a Point-to-Point Protocol (PPP) and transmitted through a tunnel using L2TP and PPTP. In such the manner, the VPN is generally configured by using the same product in order to provide consistency of VPN services since interoperability between different kinds of products is not guaranteed yet.

On the contrary, compatibility between different kinds of products and expandability is considered in the case of IPSec which corresponds to L3VPN. Since an authentication header of IPSec guarantees data integrity and an Encapsulated Security Payload (EPS) guarantees data confidentiality, many products from domestic or foreign companies, supporting it, are available nowadays.

As methods for PPVPN, a Border Gateway Protocol (BGP)/MPLS(RFC2547bis) method and a virtual router based VPN method are available in the layer 3. Also, a L2MPLS based VPN and a virtual private LAN service (VPLS) exist in the layer 2.

The MPLS is a technology which utilizes advantages of ATM technologies in an IP network, a connection-oriented technology, and a tunneling technology using a label stack. Since the MPLS provides superb Quality-of-Service (QoS) functions and supports extensive protection functions, it has replaced conventional tunneling protocols, and become a core technology of VPN technologies provided from network operators.

Since a virtual private network which mainly uses the above-mentioned VPN methods is usually based on the End-to-End manner, it describes only a method of connecting two arbitrary domain networks. Thus, there are many shortcomings in using it for connecting various points simultaneously.

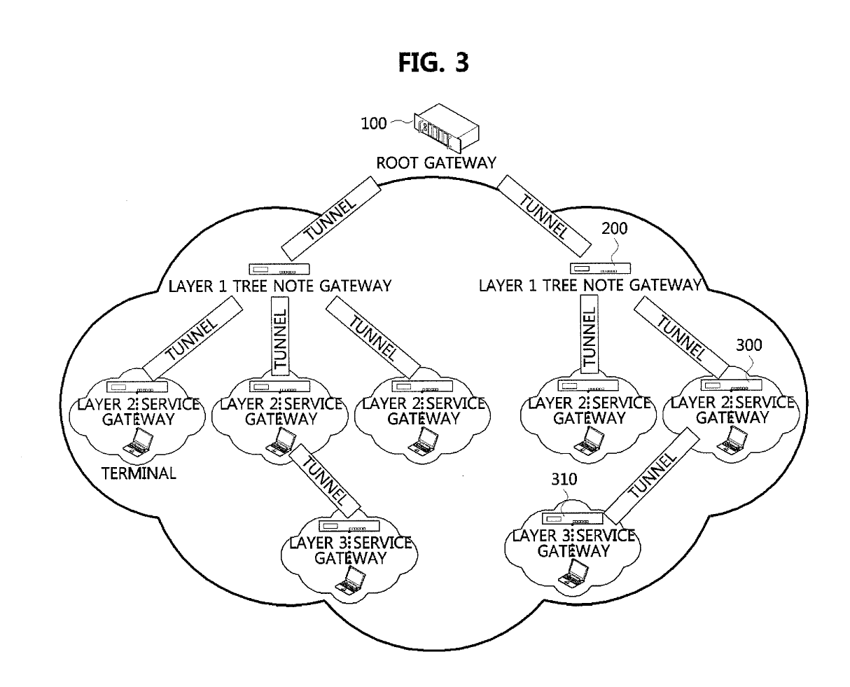

FIG. 2 is a conceptual diagram to illustrate a general VPN connection according to a star-type connection method in a center concentration manner.

A VPN connection method illustrated in FIG. 2 is a method in which a single center domain network is connected to a plurality of domain networks in the End-to-End manner. A separate gateway such as a router is located in the center domain network, and the center domain network and each of a plurality of domain networks is connected through the gateway.

Since all traffics are concentrated on the center domain network in the above-described method, excessive network loads may be caused, and the overall network may be stopped when a network failure occurs in the center domain network. In addition, since expandability of the above-mentioned method is significantly restricted, it is not suitable to an application in which a great number of branch domain networks geographically distributed in a wide area should be connected.

In a method of constructing a hierarchical virtual private network, according to an example embodiment of the present invention, for resolving the above-mentioned problems, VPN gateways are configured as a hierarchical tree structure in order to connect VPN points distributed in a wide area, and a virtual private network is constructed as it includes a tree node gateway including a root gateway and service gateways performing encryption/decryption in each VPN point.

Each service gateway has a single parent root node gateway in its upper layer, and all tree node gateways except the root gateway are connected to a single parent root node gateway.

Each gateway may be connected to each other through a secured tunnel using IPSec or a Secure Sockets Layer (SSL).

The IPSec is a standard protocol which has advanced for security of networks or packet process layers in a network communication, and may be used valuably specifically for implementation of a remote user access through a VPN and a dial-up connection to a VPN as compared to that security functions are performed in an application layer of communication model in the conventional security techniques. The great advantage of IPSec is that security is prepared without changing computer configuration of an individual user.

Basically, the IPSec provides two kinds of security services including an authentication header (AH) for allowing authentication on a data sender, and an Encapsulating Security Payload (EPS) supporting both data encryption and authentication on a data sender. The specific information related to such the service is inserted in a packet within a header following an IP packet header.

Also, the SSL is a protocol providing privacy and integrity between two communication applications using TCP/IP. Data exchanged between a client and a server is encrypted by using a symmetric algorithm.

A public key algorithm (RSA: Rivest Shamir Adleman) used in the SSL protocol is used for an encryption key exchange and a digital signature. The public key code defines an algorithm using two keys used for encrypting messages. If a key is used for encrypting messages, the other key is used for decrypting the messages. A key (a public key) is made public, and the other key (a private key) is hidden so that the messages can be received safely.

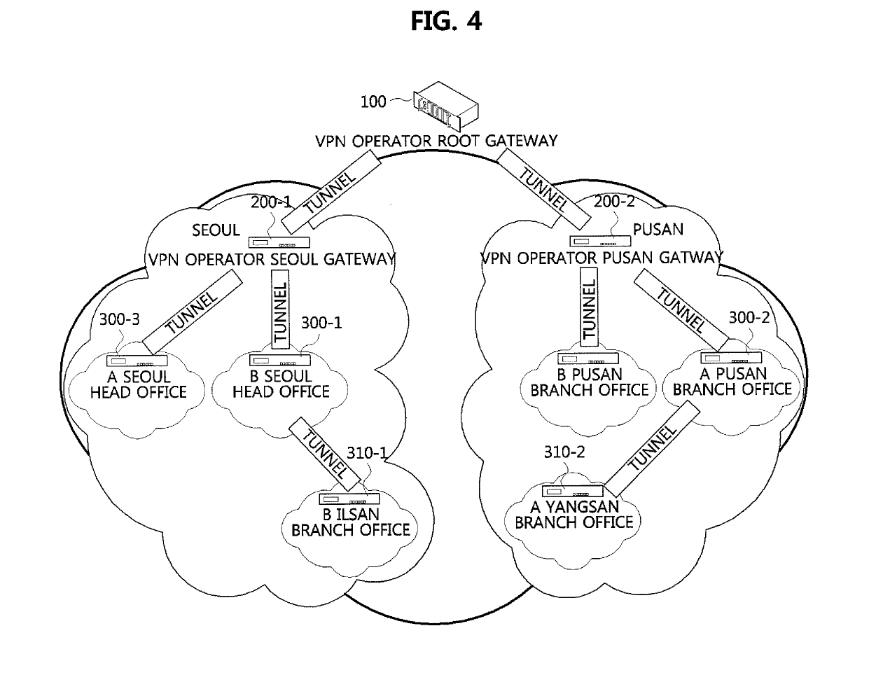

FIG. 3 is a conceptual diagram to illustrate a configuration of a virtual private network having a hierarchical structure according to an example embodiment of the present invention.

In the present invention, in order to construct a virtual private network hierarchically, VPN gateways are classified into a tree node gateway 200 and service gateways 300 and 310 as shown in FIG. 3. The root gateway 100, located in a top of a hierarchy of a virtual private network according to the present invention, may be regarded as one of the tree node gateways.

The tree node gateway 200 is a gateway for constructing a hierarchical tree structure, and does not provide actual services. The service gateways 300 and 310 are gateways used for a terminal to access an actual service domain network.

Each of the service gateways 300 and 310 is installed in each domain network distributed in a wide area, encrypts user data of the corresponding service domain network, and transmits the encrypted user data to an upper tree node gateway. Each of the service gateways 300 and 310 acts a role of decrypting the encrypted user data inputted from the upper tree node gateway, and transmitting the decrypted data to the inside of each domain network.

The tree node gateway 200 acts a role of routing a tunneled encrypted packet. If there is not a service domain network for which the tree node gateway is responsible, it does not perform encryption/decryption functions.

Each service gateway may have at least one service gateway in its lower layer. When a service gateway has at least one service gateway in its lower layer, the service gateway may also perform a function of transmitting and distributing an encrypted tunneled packet to its lower, similarly to the role of the tree node gateway 200.

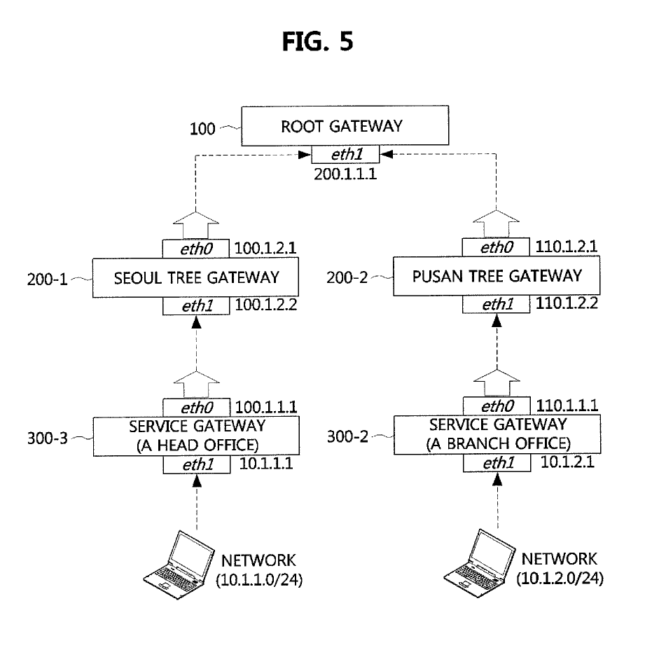

FIG. 4 is a view to illustrate an example of utilizing a VPN service using a method of constructing a virtual private network according to an example embodiment of the present invention.

The virtual private network depicted in FIG. 4 is an example of a virtual private network for helping to understand a VPN service using a method of constructing a virtual private network having a hierarchical structure according to the present invention.

A nation-wide VPN service operator may install tree node gateways 200-1 and 200-2, including a root gateway 100, each of which is responsible for each province, and make service gateways for each domain network be connected to each tree node gateway.

As shown in FIG. 4, a head office of a company A, located in Seoul, may be connected to a Seoul gateway 300-3 of the VPN operator. Also, a branch office of company A, located in Pusan, may be connected to a Pusan gateway 300-2 of the VPN operator through a secured tunnel. Each of tree node gateways 200-1 and 200-2 is connected to each other through the root gateway 100 of the VPN operator.

In other words, the VPN operator only needs to install a service gateway in a domain network which needs a VPN service, and connect the service gateway to an upper tree node gateway in order to provide a VPN service. A detail procedure for tunnel connection and a detail method for tunnel routing will be described in the following.

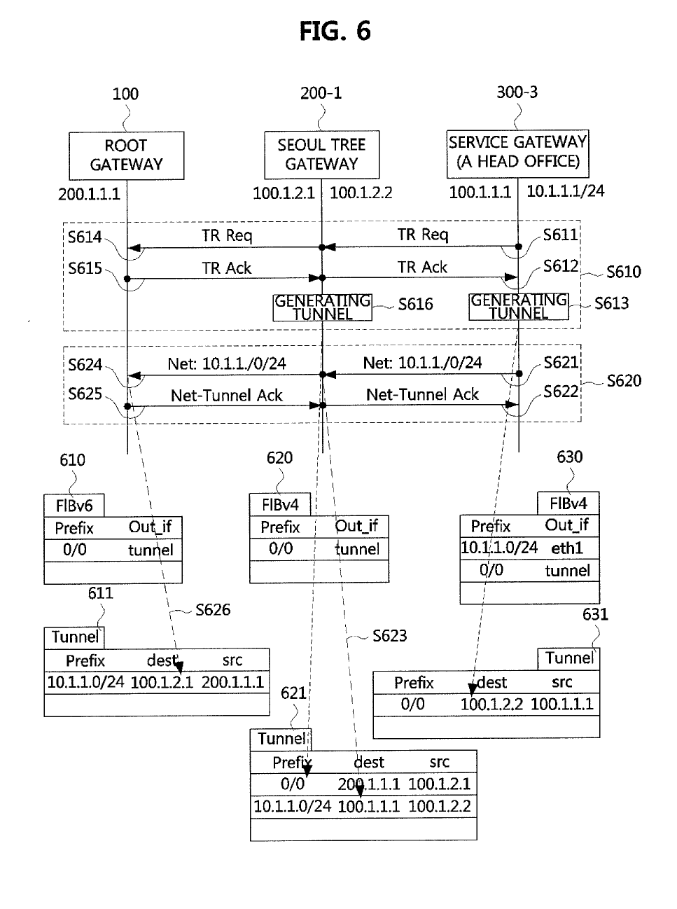

FIG. 5 is a conceptual diagram to illustrate a method for tunnel connection and tunnel routing according to an example embodiment of the present invention.

The procedure for tunnel connection and the method for tunnel routing illustrated in FIG. 5 are based on a virtual private network according to an example embodiment of the present invention illustrated in FIG. 4.

In order to describe a detail procedure for tunnel connection and a detail method for tunnel routing, for example, a case in which the tunnel connection between the Seoul head office and the Pusan branch office of the company A is established and a tunnel routing table for it is configured in the example illustrated in FIG. 4, will be explained in FIG. 5.

Referring to FIG. 5, it is supposed that a sub-network of the Seoul head office of the company A is configured as 10.1.1.0/24 and a sub-network of the Pusan branch office is configured as 10.1.2.0/24. Each sub-network may be a public IP network or a private IP network. However, it is preferred that a private IP network is used for actual configuration of the virtual private network.

There exists a respective service gateway for each region in order to connect a sub-network of each region to the virtual private network. That is, a service gateway 300-3 of the head office located in Seoul and a service gateway 300-2 of the branch office located in Pusan may perform such the function. Each gateway is configured to comprise an uplink interface and a downlink interface for transmitting packets.

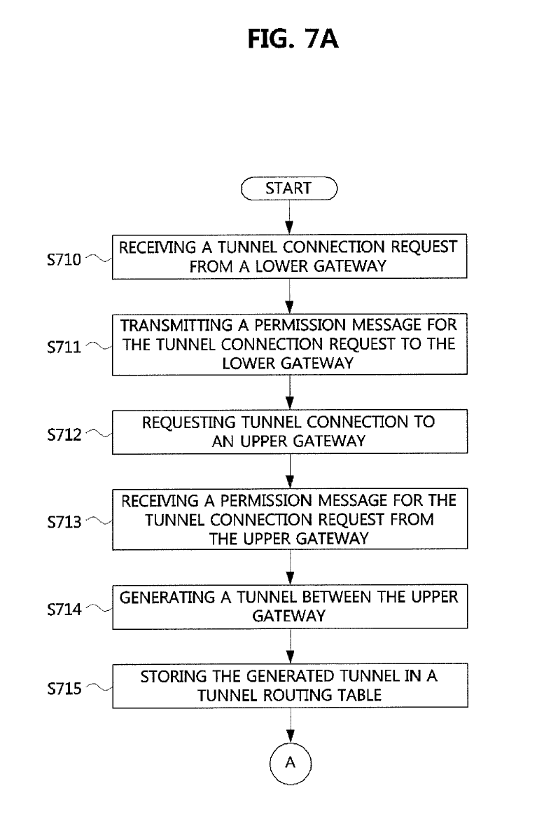

FIG. 6 is a view to illustrate a procedure for tunnel connection and a method for configuring a tunnel routing table according to an example embodiment of the present invention.

The procedures illustrated in FIG. 6 may include a procedure 5610 for tunnel connection and a procedure S620 for generating a tunnel routing table.

The gateways according to an example embodiment of the present invention may include, respectively, tunnel routing tables 611, 621, and 631 for configuring a hierarchical VPN in addition to conventional routing tables 610, 620, and 630.

According to an example embodiment of the present invention, a tunnel connection is requested from a lower gateway to an upper gateway. As shown in FIG. 6, the service gateway 300-3 of the Seoul head office may transmit a tunnel connection request message (TR Req) to a Seoul tree gateway 200-1 located above the service gateway 300-3 in order to connect a VPN (S611).

The Seoul tree gateway 200-1, which receives the tunnel connection request message, may perform a predetermined authentication procedure, and transmit a tunnel connection permission message (TR Ack) to the service gateway 300-3 of the head office when the authentication condition is satisfied (S612).

The head office service gateway 300-3, which receives the tunnel connection permission message, may generate a tunnel entry (0/0→100.1.2.2:100.1.1.1) in the tunnel routing table 631 in order to transmit all packets inputted to the VPN to the Seoul tree gateway (S613). That is, the head office service gateway 300-3 inserts tunnel headers (having a destination address 100.1.2.2 and a source address 100.1.1.1) in all packets which will be transmitted to the Seoul tree gateway 200-1 so that the corresponding packets will be transmitted to the Seoul tree gateway 200-1.

Here, the head office service gateway 300-3 may perform encryption and decryption procedures on the packets which will be transmitted to the Seoul tree gateway 200-1 before the tunnel headers are inserted into the packets.

Similarly, the Seoul tree gateway 200-1 may also request a tunnel connection (TR Req) to the root gateway 100 for a tunnel connection with the root gateway 100 (S614). The root gateway 100 which received the tunnel connection request message may perform a predetermined authentication procedure, and transmit a tunnel connection permission message (TR Ack) to the Seoul tree gateway 200-1 when an authentication condition is satisfied (S615).

The Seoul tree gateway 200-1, which receives the tunnel connection permission message, may generate a tunnel entry (0/0→200.1.1.1:100.1.2.1) in the tunnel routing table 621 (S616). That is, the Seoul tree gateway 200-1 inserts tunnel headers (having a destination address 200.1.1.1 and a source address 100.1.2.1) in all packets which will be transmitted to the root gateway 100 so that the corresponding packets will be transmitted to the root gateway 100.

A method, in which the root gateway 100 and the tree gateways responsible for each region are configured, in advance, by a VPN service operator, may be used.

If the tunnel connection procedure 5610 is completed, a procedure S620 of generating a route for tunnel routing is performed.

The head office service gateway 300-3 may transmit a route configuration request message to the upper Seoul tree gateway 200-1 for configuring a routing to a prefix 10.1.1.0/24 of corresponding sub-network (S621).

Accordingly, the Seoul tree gateway 200-1 generates a tunnel routing entry (10.1.1.0/24→100.1.1.1:100.1.2.2) for the corresponding prefix, and inserts it in the tunnel routing table (S623). Also, in order to notify the routing entry to the upper entity, the Seoul tree gateway 200-1 transmits the same route configuration request message to the root gateway 100 (S624).

Identically to the procedure of generating the routing entry in the Seoul tree gateway 200-1, the root gateway 100 generates a tunnel routing entry (10.1.1.0/24→100.1.2.1:200.1.1.1) by setting an address of the Seoul tree gateway 200-1 as a destination address, and inserts the generated tunnel routing entry in the tunnel routing table (S626).

The above-described procedure of generating the tunnel routing table is identically applied to the Pusan branch office service gateway 300-2, the Pusan tree gateway 200-2, and the root gateway 100 so that the tunnel routing table for each VPN service sub-network will be configured.

Through the procedure illustrated in FIG. 6, a hierarchical virtual private network according to an example embodiment of the present invention may be configured.

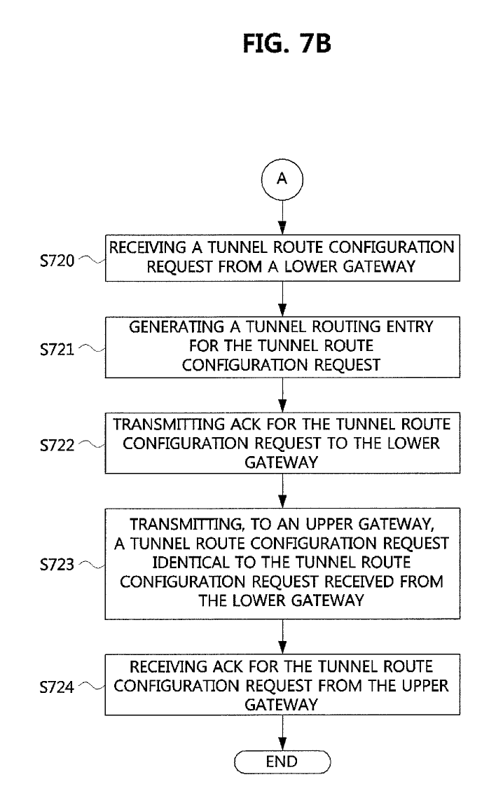

FIGS. 7A and 7B are flow charts of a method of constructing a hierarchical virtual private network according to an example embodiment of the present invention.

In an example embodiment of FIGS. 7A and 7B, the flows described in FIG. 6 will be explained from a viewpoint of a gateway. Also, in description of the example embodiment below, each step of constructing a hierarchical virtual private network of the present invention may be understood as an operation performed in a corresponding element in the gateway apparatus described with reference to FIG. 6, however the individual steps of the method should only be limited by their own functions by which they are defined. That is, main agents performing the steps are not limited by the names of elements illustrated as performing the steps in the examples.

According to a method of constructing a hierarchical virtual private network of the present invention, first, a tunnel connection request is received from a lower gateway (S710), and a permission message for the tunnel connection request is transmitted to the lower gateway (S711). At this time, the lower gateway receives the permission message for the tunnel connection request, and generates a tunnel according to the permission message.

Then, a gateway requests a tunnel connection to an upper gateway (S712), and receives a permission message for the tunnel connection request from the upper gateway (S713). When the permission message for the tunnel connection request is received from the upper gateway, a tunnel is generated between the gateway and the upper gateway (S714), and the generated tunnel is stored in a tunnel routing table (S715).

Through the above-described procedures, the procedure of generating a tunnel is completed.

Then, the gateway receives a tunnel route configuration request from a lower gateway (S720), and generates a tunnel routing entry for the tunnel route configuration request (S721). The gateway also transmits an acknowledgement (ACK) for the configuration request from the lower gateway to the lower gateway (S722). The gateway transmits a route configuration request identical to the tunnel route configuration request received from the lower gateway to an upper gateway (S723). When an acknowledgement (ACK) for the route configuration request is received from the upper gateway (S724), the procedure of generating a route is completed.

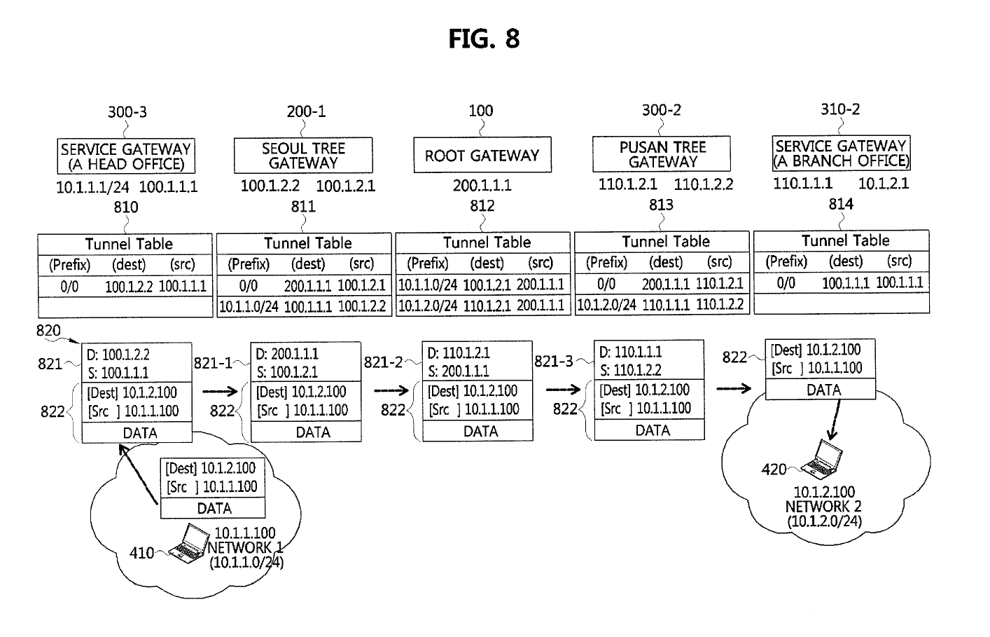

FIG. 8 is a flow chart to illustrate an operation for tunnel routing of a VPN service packet according to an example embodiment of the present invention.

In FIG. 8, a method and a procedure for tunnel routing on a VPN service packet according to a tunnel routing table generated by each gateway are illustrated. The procedures of FIG. 8 are supposed to have base-conditions identical to the examples of configuring a VPN, configuring a tunnel, and configuring a route which were described through FIGS. 4 to 6.

In FIG. 8, as a specific example, explained is a case in which a packet is actually tunnel-routed when a first terminal (410, address 10.1.1.100), belonging to a service sub-network (network 1, address: 10.1.1.0/24) to which a Seoul head office service gateway 300-3 is connected, transmits a packet to a second terminal (420, address 10.1.2.100), belonging to a service sub-network (network 2, address: 10.1.2.0/24) to which a Pusan branch office service gateway 300-2 is connected.

In an upper part of FIG. 8, a head office service gateway 300-3, a Seoul tree gateway 200-1, a root gateway 100, a Pusan tree gateway 300-2, and a branch office service gateway 310-2 are illustrated as gateways through which a packet transmitted from the first terminal 410 to the second terminal 420 flows.

In FIG. 8, each of tunnel routing tables 810, 811, 812, 813, and 814, which is managed by each gateway, is illustrated below the corresponding gateway. Also, packet data 820 which is transmitted by each gateway is illustrated below them.

The first terminal 410 (address: 10.1.1.100) is supposed to transmit a packet having an address of the second terminal (10.1.2.100) as its destination address to the head office service gateway 300-3.

A forwarding engine of the head office service gateway 300-3 which the first terminal 410 accesses searches the tunnel routing table 810 for the packet received from the first terminal 410. The corresponding packet is matched to a default route (0/0→100.1.2.2/100.1.1.1), and the head office service gateway 300-3 inserts a header 821 having a destination address (100.1.2.2) and a destination address (100.1.1.1) in data 820 of the packet which will be transmitted, and transmits the packet to the Seoul tree gateway 200-1.

The Seoul tree gateway 200-1, which receives the packet from the service gateway 300-3, removes a tunnel header 821 from the packet received from the service gateway 300-3, and searches the tunnel routing table 811 for a destination address (10.1.2.100) of an original IP header. If the corresponding packet is matched to a tunnel route (0/0→200.1.1.1/100.1.2.1), the Seoul tree gateway 200-1 may insert a header 821-1 having a destination IP address (200.1.1.1) and a source IP address (100.1.2.1) in a data packet which will be transmitted, and transmit the packet to the root gateway 100.

The root gateway 100, which receives the tunneled packet, may remove the tunnel header 821-1 from the received packet, and search the tunnel routing table 812 for a destination address (10.1.2.100) of an original IP header. The root gateway 100 may obtain a search result that the corresponding packet is matched to a tunnel routing entry (10.1.2.0/24→110.1.2.1/200.1.1.1). The root gateway 100 may insert a tunnel header 821-2 in a packet which will be transmitted, and transmit the packet to the Pusan tree gateway 300-2.

The Pusan tree gateway 300-2, which receives the tunneled packet, may remove the tunnel header 821-2 of the packet received from the root gateway 100, and search the tunnel routing table 813 for a destination address (10.1.2.100) of an original IP header. The Pusan tree gateway 300-2 may obtain a search result that the corresponding packet is matched to a tunnel routing entry (10.1.2.0/24→110.1.1.1/110.1.2.2). The Pusan tree gateway 300-2 may insert a tunnel header 821-3 in a packet which will be transmitted, and transmit the packet to the branch office service gateway 310-2.

The branch office service gateway 310-2 may remove the packet header 821-2 from the received packet, and transmit data 822 of the packet to a final destination, the second terminal 420.

In summary, in an example embodiment of FIG. 8, a packet which the first terminal desires to transmit to the second terminal 420 includes an IP header including an address of the first terminal as an original source and an address of the second terminal as an original destination, and a payload 822 including actual data. The packet may flow through the head office service gateway 300-3, the Seoul tree gateway 200-1, the root gateway 100, the Pusan tree gateway 300-2, and the branch office service gateway 310-2. The packet is transmitted through a tunnel configured between gateways belonging to the path.

For this, each of tunnel headers 821, 821-1, 821-2, and 821-3 according to a tunnel through which the corresponding packet flows currently is attached to the packet 822 which will be transmitted actually. Each tunnel header is removed after the transmission of the packet through the corresponding tunnel is completed, and a new tunnel header is attached in order for the packet to flow through the new corresponding tunnel.

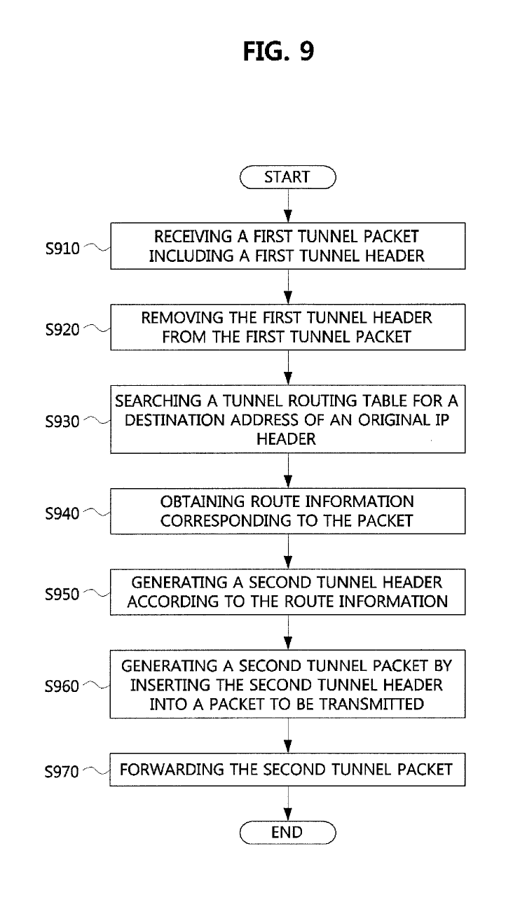

FIG. 9 is a flow chart to illustrate a method for packet forwarding according to an example embodiment of the present invention.

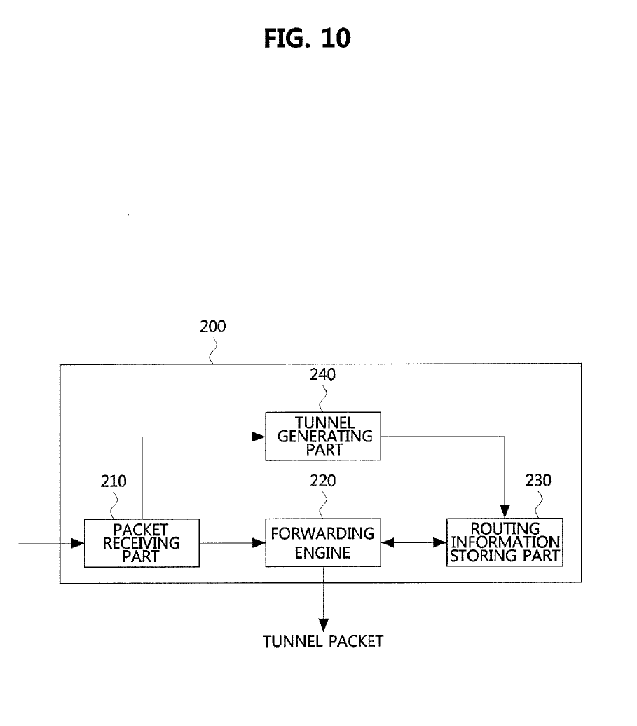

In description of the example embodiment below, each step of a method for packet forwarding according to the present invention may be understood as an operation performed in a corresponding element in the gateway apparatus described with reference to FIG. 10, however the individual steps of the method should only be limited by their own functions by which they are defined. That is, main agents performing the steps are not limited by the names of elements illustrated as performing the steps in the examples.

In a method for packet forwarding according to an example embodiment of the present invention, a first tunnel packet including a tunnel header comprising a first tunnel header may be received (S910), and the first tunnel header may be removed from the received first tunnel packet (S920).

If the tunnel header is removed, a tunnel routing table is searched for a destination address of an original IP header included in a payload of the packet (S930), and route information corresponding to the packet is obtained (S940). Here, the tunnel routing table may manage information about at least one tunnel managed by the corresponding gateway in a form of table, and may include a destination address and a source address for a prefix of each tunnel.

If the route information is obtained, the second tunnel header is generated according to the route information (S950). The second tunnel packet may be generated by inserting the to generated second tunnel header into a packet which will be transmitted (S960), and the generated second tunnel packet may be forwarded to a next destination (S970).

On the other hand, a method for packet forwarding according to another example embodiment of the present invention, which is related to a method for packet forwarding of a tree gateway hierarchically connected to at least one other gateway, may be configured to comprise a step of performing a tunnel connection with the at least one other gateway connected to the tree gateway hierarchically in upper relation or in lower relation, a step of generating a tunnel route for a tunnel route configuration request received through the connected tunnel, and a step of performing a tunnel header process on a packet inputted through the generated tunnel route.

FIG. 10 is a block diagram to illustrate a tree gateway according to an example embodiment of the present invention.

Components which will be described below are classified functionally rather than physically, and may be defined by functions performed by each component. Each component may be implemented by hardware and/or a program code and a processing unit which perform each function, and implemented in such a manner that functions of at least two components are included in a single component.

Therefore, in the following embodiments, names given to components are given to imply a representative function performed by each component rather than physical separation, and it should be noted that the technical spirit of the present invention is not limited by the names of components.

Referring to FIG. 10, a gateway apparatus according to a preferable example embodiment of the present invention may include a packet receiving part 210, a forwarding engine 220, a routing information storing part 230, and a tunnel generating part 240.

The packet receiving part 210 of the gateway apparatus 200 receives packets from other connected gateway apparatuses or network elements. The packets received by the packet receiving part 210 may include a tunnel generation request, a route generation request, and a tunnel packet which will be forwarded, etc. When the received packet is a packet related to the tunnel generation request or the route generation request, the corresponding request is delivered to the tunnel generating part 240.

If the packet received by the packet receiving part 210 is a tunnel packet including a tunnel header, the packet receiving part 210 transmits the received packet to the forwarding engine 220.

The forwarding engine 220, which receives the tunnel packet from the packet receiving part 210, removes the tunnel header from the tunnel packet. Also, the forwarding engine searches a destination address of an original IP header included in data of the packet whose tunnel header is removed in a tunnel routing table managed by the routing information storing part 230, and acquires routing information corresponding to the packet.

The forwarding engine 220, which acquires the routing information may generate a new tunnel header according to the acquired routing information, may insert the generated tunnel header in a packet which will be transmitted, and forward the packet to a next destination.

The routing information storing part 230 may store various routing information in general routing tables 610, 620, and 630, and tunnel routing tables 611, 621, and 631. The tunnel routing tables 611, 621, and 623 manages information about at least one tunnel and route which is managed by corresponding gateway. The information may include destination addresses and source addresses for prefixes of each tunnel and each route.

On the other hand, the tunnel generating part 240 may receive a tunnel generation request or a route generation request from the packet receiving part 210, and generate tunnel or route information according to the request. Specifically, the tunnel generating part 240 may generate a tunnel connected to at least one other gateway, which is connected hierarchically in the upper or in the lower, and generate a tunnel route according to a tunnel route configuration request received through the connected tunnel.

The tree gateway apparatus, according to the present invention, including blocks illustrated in FIG. 1, receives a packet including a tunnel header 1, and forwards a packet including a tunnel header 2 different from the tunnel header 1.

According to the above-described present invention, problems of conventional VPN technologies based on simple End-to-End connections may be resolved.

Also, according to the present invention, obtained is an advantage that a great number of domain networks distributed in a wide area can be connected and used easily, flexibly, and in the expandable manner.

While the example embodiments of the present invention and their advantages have been described in detail, it should be understood that various changes, substitutions and alterations may be made herein without departing from the scope of the invention.

What is claimed is:

1. A method for constructing a virtual private network, performed in a gateway connected to an upper gateway and a lower gateway, the method comprising:
receiving a connection request of a first tunnel from the lower gateway, and transmitting a permission message for the connection request of the first tunnel to the lower gateway;
transmitting a connection request of a second tunnel to the upper gateway, and receiving a permission message for the connection request of the second tunnel from the upper gateway; and
generating the second tunnel, and storing information about the second tunnel in a tunnel routing table.

2. The method of claim 1, further comprising:
receiving a tunnel route configuration request from the lower gateway;
generating a tunnel routing entry for the tunnel route configuration request; and
transmitting, to the upper gateway, a request identical to the tunnel route configuration request received from the lower gateway.

3. The method of claim 1, wherein the first tunnel is generated by the lower gateway.

4. The method of claim 2, wherein the tunnel routing table includes at least one tunnel routing entry.

5. The method of claim 4, wherein the tunnel routing table includes information about a prefix, a destination address, and a source address for each tunnel routing entry.

6. The method of claim 1, further comprising receiving a first tunnel packet through the first tunnel and the second tunnel.

7. The method of claim 6, further comprising:
removing a first tunnel header included in the first tunnel packet;
searching the tunnel routing table for a destination address of an original data in the first tunnel packet in which the first tunnel header is removed; and
obtaining route information corresponding to the first tunnel packet through the tunnel routing table search.

8. The method of claim 7, further comprising:
generating a second tunnel header according to the obtained route information;
generating a second tunnel packet by inserting the second tunnel header into an original packet data to be forwarded; and
forwarding the generated second tunnel packet.

9. The method of claim 8, wherein the first tunnel header includes a source address and a destination address of the first tunnel, and the second tunnel header includes a source address and a destination address of the second tunnel.

10. A method for packet forwarding, performed in a tree gateway connected hierarchically to at least one other gateway, the method comprising:
performing a tunnel connection with the at least one other gateway connected to the tree gateway hierarchically in an upper relation or a lower relation;
generating a tunnel route according to a tunnel route configuration request received through the connected tunnel; and
performing a tunnel header process on a packet inputted through the generated tunnel route.

11. The method of claim 10, further comprising transmitting the packet on which the tunnel header process is performed.

12. The method of claim 10, wherein the performing a tunnel header process on a packet inputted through the generated tunnel route comprises:
removing a first tunnel header included in a first tunnel packet received; and
generating a second tunnel packet by inserting a second tunnel header into the packet the first tunnel header of which is removed according to the tunnel route.

13. A tree gateway apparatus connected hierarchically to at least one other gateway, comprising:
a tunnel generating part generating a tunnel connected to at least one other gateway connected hierarchically to the tree gateway apparatus in an upper position or a lower position, and generating a tunnel route according to a tunnel route configuration request received from the connected tunnel; and
a routing information storing part storing information about the generated tunnel and the tunnel route.

14. The tree gateway apparatus of claim 13, further comprising a packet receiving part receiving a packet including at least one of a tunnel generation request, a route generation request, and a tunnel packet from the at least one other gateway connected hierarchically.

15. The tree gateway apparatus of claim 14, further comprising a forwarding engine searching a tunnel routing table stored in the routing information storing part for a destination address of an original IP header included in a tunnel packet received from the packet receiving part, and obtaining route information corresponding to the packet.

16. The tree gateway apparatus of claim 15, wherein the forwarding engine generates a new tunnel header according to the obtained route information, inserts the tunnel header into a packet to be transmitted, and forwards the generated packet to a next destination.

17. The tree gateway apparatus of claim 16, wherein the forwarding engine removes a first tunnel header included in a first tunnel packet received, generates a second tunnel packet by inserting a second tunnel header into a packet the first tunnel header of which is removed according to the tunnel route information, and forwards the generated second tunnel packet.

18. The tree gateway apparatus of claim 13, wherein the routing information storing part includes a tunnel routing table comprising at least one tunnel routing entry.

19. The tree gateway apparatus of claim 18, wherein the tunnel routing table includes information about a prefix, a destination address, and a source address for each tunnel routing entry.
